(19) United States
(12) Patent Application Publication
(10) Pub. No.: US 2010/0070419 A1
(43) Pub. Date: Mar. 18, 2010

(54) SYSTEM AND METHOD TO INITIATE A FUNCTION WITH AN EMAIL MESSAGE

(76) Inventor: Srinivas Vadhri, Cupertino, CA (US)

Correspondence Address: SCHWEGMAN, LUNDBERG & WOESSNER/EBAY, P.O. BOX 2938, MINNEAPOLIS, MN, 55402, US

(21) Appl. No.: 12/211,891

(22) Filed: Sep. 17, 2008

(51) Int. Cl. G06Q 20/00; H04L 9/32

(52) U.S. Cl. 705/71; 705/44

(57) ABSTRACT

This document discusses, among other things, initiating a function with an email message. Various example embodiments relate to a machine that is to receive an email message. The machine may determine, based on an email address of the sender, whether the sender is a valid sender. In some example embodiments, based on the machine determining that the sender is valid, the machine may execute a command included within the email message.

### TECHNICAL FIELD

This patent document pertains generally to electronic communication and more particularly, but not by way of limitation, to initiating a function with an email message.

### BACKGROUND

A machine associated with one or more processors may be connected to a network. A processor may execute instruction to implement one or more operating systems. An operating system may cause execution of instructions to implement one or more applications. An application may cause the execution of instructions to provide a function.

Email messages are typically communicated between a sender and a receiver over a network. An email message may include multiple fields that are to include information related to the email message.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a block diagram showing an example network, in accordance with an example embodiment;

FIG. 2 is a block diagram showing an example of a digital signature, in accordance with an example embodiment;

FIG. 3 is a flow diagram illustrating an example method for initiating a function with an email message, in accordance with an example embodiment;

FIG. 4 shows a mockup of an email message, in accordance with an example embodiment;

FIG. 5 is a flow diagram illustrating a method for crediting an account, in accordance with an example embodiment;

FIG. 6 is a flow diagram illustrating a method for validating a sender, in accordance with an example embodiment;

FIG. 7 is a network diagram depicting a client-server system, in accordance with an example embodiment;

FIG. 8 is a block diagram illustrating multiple applications that, in an example embodiment, are provided as part of a networked system;

FIG. 9 is a high-level entity-relationship diagram, illustrating various tables that may be maintained within databases, and that are utilized by and support applications; and

FIG. 10 shows a diagrammatic representation of a machine in the example form of a computer system, in accordance with an example embodiment.

### DETAILED DESCRIPTION

### Overview

In various example embodiments, a payment may be made from one value holding account to another value holding account holder, via an email message signed with a digital signature.

A payor, using a machine (e.g., handheld or desktop), may compose an email message using, for example, an email application or a web-based email interface. The email message may include one or more commands that may cause one or more functions to be executed. The one or more commands may be included in a subject field (e.g., subject line) of the email message. In some example embodiments, the email message may include in its subject line a payment command, an email address indicating a payee and a dollar or other currency amount to be paid to the payee. In some example embodiments, a payor may address the email message to an example secure server and digitally sign it before transmitting the email message to the secure server, via the Internet.

For some example embodiments, the secure server is to receive the email message and attempt to validate the sender of the email message by verifying the digital signature. The sender may be validated or invalidated based on an email address in the “From” field of the email message or based on an alias email address associated with the sender. Based on validating the sender, the secure server may extract the function command, the currency amount to be paid, and the payee from the email message. In some example embodiments, the secure server may generate a function call based on the payment command, the currency amount, and the payee and forward the function call to a payment application to be processed.

It may be noted that, although the example embodiments refer to the email messages being related to payment functions, the methods and systems described herein may also be used with the email messages that are related to other types of function.

In various example embodiments, execution of the function call may include the payment application accessing a user database to identify a value holding account associated with the email addresses of the payor and the payee. Execution of the function call may further include the payment application transferring the dollar or other currency amount to be paid from the value holding account of the payor to the value holding account of the payee. The example embodiments above describe examples of making a payment from a payor to a payee, via email message.

This overview is intended to provide an overview of the subject matter of the present patent application. It is not intended to provide an exclusive or exhaustive explanation of what is claimed. The detailed description is included to provide further information about the subject matter of the present patent application.

The following detailed description includes references to the accompanying drawings, which form a part of the detailed description. The drawings show illustrations in accordance with example embodiments. These embodiments, which are also referred to herein as “examples,” are described in enough detail to enable those skilled in the art to practice the claimed subject matter. The embodiments may be combined, other embodiments may be utilized, or structural, logical and electrical changes may be made without departing from the scope what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

### EXAMPLE EMBODIMENTS

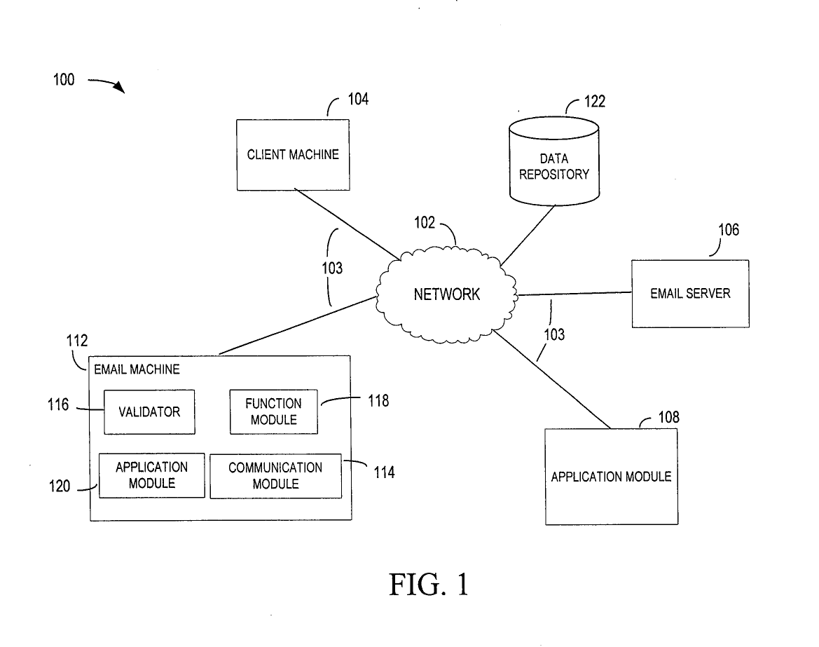

FIG. 1 is a block diagram 100 showing an example network 102, in accordance with an example embodiment. FIG. 1 is shown to include the network 102 communicatively coupled to a client machine 104, an email server 106, an application module 108 and an email machine 112, via transmission media 103.

The example network 102 is a communicative coupling of two or more machines. One or more types of networks and/or communication protocols may be used to implement the example network. In an example embodiment, the network may include a wide area network (WAN) and a local area network (LAN) that carries Internet protocol (IP) frames over various transmission media 103 such as twisted pairs, wireless and/or optical fiber. Example embodiments may include other types of networks, network topologies and/or communication protocols without departing from the claimed subject matter.

The example client machine 104 is to execute various instructions. In an example embodiment, one or more processors are included within the machine to process instructions associated with one or more virtual machines, operating systems and/or applications. In an example embodiment, the client machine 104 includes a central processing unit (CPU) to process instructions for an email application. The example email application (e.g., a desktop email application) may allow a user of the client machine 104 to send and/or receive email messages to and from other users using other client machines that are communicatively coupled to the network 102. Any email application may be used to allow the client machine 104 to send and/or receive email. In some example embodiments, the client machine 104 may include a web browser (not shown) allowing a user of the client machine 104 to send and receive email messages via the email server 106.

For some example embodiments, the client machine 104 allows a user to generate and send an email message that includes sender validation information, a function command and function input information. For some example embodiments, the sender validation information includes at least one of a public key certificate and/or a digital signature.

The email server 106 is to provide email services to the user using the client machine 104. In an example embodiment, the email server 106 is to receive an email message from the client machine 104 and forward the email message to a desired recipient. The email message may be sent from an email application or a web browser being implemented on the client machine 104. The email server 106 may include a CPU to execute instructions associated with providing email services to the client machine 104 or multiple client machines to which the email server 106 is communicatively coupled. An example email server 106 may include instructions to allow an email address to be validated by a receiver of the email message. For example, the email server 106 may forward an email message with validation information (e.g., a public key certificate and/or digital signature).

The application module 108 may be associated with one or more processors and application modules to execute instructions for the purpose of implementing one or more applications. In an example embodiment, an application may provide a function or various functions based on one or more function calls, which are themselves instructions. Some function calls that are expressed according to a particular protocol or language may be integrated with other instructions that are expressed according to a different protocol or language than the function call is expressed. Some function calls may include an input parameter or value. In various example embodiments, the application module 108 is to receive a function call from the email machine 112 (e.g., from the function module 118, discussed below) and may return an output based on the received function call. In some example embodiments, the function call is based on an email message originally from the client machine 104 that may include a function command and input data associated with the function call.

The email machine 112 is to allow the operation of the communication module 114, the validator 116, the function module 118 and the application module 120, which the email machine 112 is shown to include. For some example embodiments, one or more of the communication module 114, the validator 116, the function module 118 and the application module 120 may be implemented outside or independent of the email machine 112.

The communication module 114 is to receive email messages from the client machine 104 and/or the email server 106, via the transmission media 103. The communication module 114 may further transmit various data from the email machine to machines that are communicatively coupled to the network 102. In an example embodiment, the communication module 114 may receive a function call from the function module 118 (discussed below) and transmit the function call to the application module 108. Alternatively or additionally, the communication module 114 may receive a function output from the application module 120 (discussed below) and transmit the function output to the client machine 104 or any other machine communicatively coupled to the network.

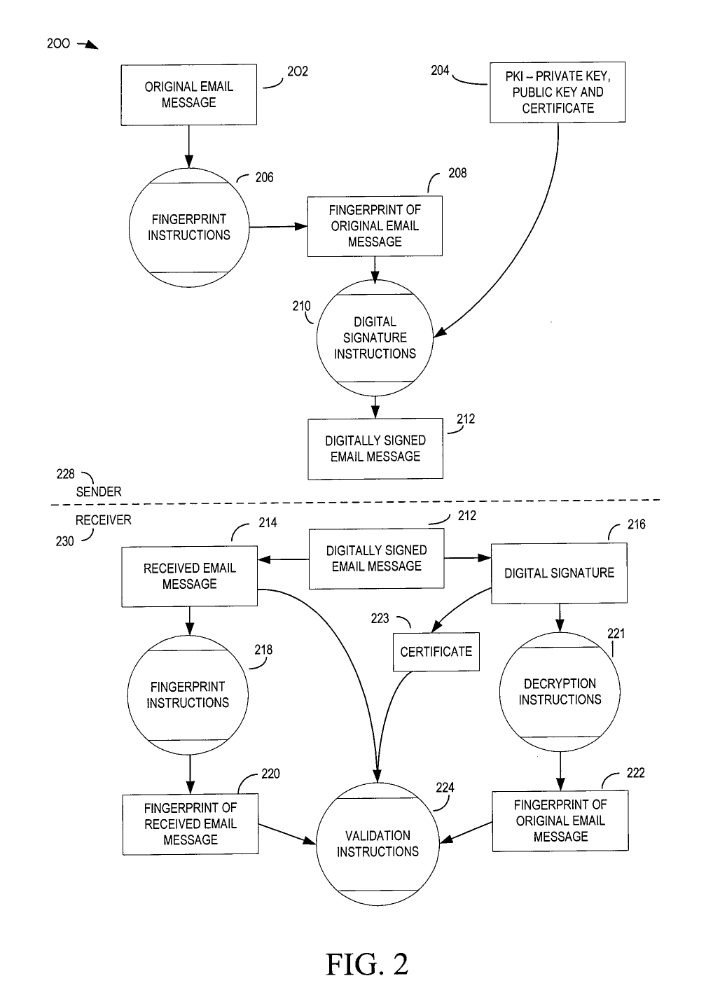

The example validator 116 may validate a sender of an email message received by the email machine 112. For some example embodiments, the validator 116 includes instructions to identify validation information sent with or associated with an email message and determine whether the sender is valid, based on the identified validation information (e.g., embedded within the email message). Validation may include authentication (e.g., determining that the sender is who the sender says the sender is) and if authenticated, ensuring that the sender is authorized regarding a service, action or access (e.g., authorized to cause a function to be executed). There are currently several techniques used to validate email from a sender. In an example embodiment the validator 116 may include instructions to implement a digital signature technique for providing validation. An example validation technique is discussed in more detail with respect to FIG. 2.

FIG. 2 is a graphical diagram 200 illustrating a digital signature technique, in accordance with an example embodiment. The graphical diagram 200 is shown to be divided into a sender side 228 and a receiver side 230. The activity on the sender side 228 is typically performed by a machine associated with a sender of an email message. For example, the example client machine 104 and/or the example email server 106 of FIG. 1 may perform some or all of the activity on the sender side 228. The activity on the receiver side 230 is typically performed by a machine associated with the receiver of the email message. In various example embodiments, the validator 116 of the email machine 112 of FIG. 1 is to perform some or all of the activity shown on the receiver side 230.

In an example embodiment, a purpose of a digitally signed email message 212 includes authenticating the sender of an original email message 202 and ensuring that the content of the original email message 202 has not been altered from its original form.

In some example embodiments, fingerprint instructions 206 (e.g., a hash algorithm) are to generate a fingerprint of the original email message 208 based on the original email message 202. Public key infrastructure (PKI) 204 information may include a private key, a public key and a certificate for the public key. The certificate for the public key may ensure that a particular sender is associated with the public key. In an example embodiment, the sender may attach the certificate to an email message before sending the email. The certificate may be stored in a sender's machine (e.g., computer or handheld device) at a hardware level (e.g., a CPU), in the sender machine's storage hard-drive or in the email server. The digital signature instructions 210 may encrypt the fingerprint of the original email message 208 using the private key of the PKI information, and combine the certificate, the public key and the encrypted email fingerprint. An example result of the above described combination is shown to be a digitally signed email message 212.

On the receiver side 230, the example digitally signed email message 212 may be divided into a received email message 214 portion and a digital signature 216 portion. The fingerprint instructions 218 may generate a fingerprint of the received email message 220 based on the received email message 214. Decryption instructions 221 may decrypt the fingerprint of the original email message 208 based on the public key within the digitally signed document.

In an example embodiment, if the validation instructions 224 determine that the fingerprint of the received email message 220 matches the fingerprint of the original email message 222, the validation instructions 224 may determine (e.g., with a degree of confidence) that the received email message 214 has not been corrupted, either deliberately or accidentally. The validation instructions 224 may further determine (e.g., with a degree of confidence) that the claimed sender (e.g., identified by the sender's email address) actually did send the email message.

The certificate 223 for the public key may be obtained from the digital signature 216 by the validation instructions 224. In some example embodiments, the validation instructions may reference a trusted third party that issued the certificate 223 who may verify that the sender of the received email message 214 (e.g., who may be identified by the sender's email address) is associated with the public key used to decrypt the encrypted fingerprint of the original email message 208. Alternatively or additionally, the certificate 223 may be used to determine whether the sender who has used the public key is the same sender (e.g., has the same email address) who has been issued the private key used to create the digitally signed email message 212.

If the validator 116 of FIG. 1 determines that the sender is not valid, for some example embodiments the validator 116 may access a data repository 122 of FIG. 1 to identify an alternative email address (e.g., an alias) that is associated with the sender address in the email. In an example embodiment, an alias email address may be used to validate a sender according to validation techniques. The use of alias email addresses are discussed in more detail below. Although the data repository 122 is shown as a node on the network 102 of FIG. 1, it may be noted that the data repository 122 and/or the contents of the data repository 122 may be located within the email machine 112 or any other machine communicatively coupled to the network 102.

If the validator 116 of FIG. 1 determines that the sender is valid, the validator 116 may allow the function module 118 of FIG. 1 to detect that state. For some example embodiments, the validator 116 may signal the function module 118 to indicate the sender's validity. Alternatively or additionally, the function module 118 may inquire whether the sender of an email message is valid.

The function module 118 of FIG. 1 is to identify one or more function commands and input data embedded in an email message received from the client machine. In some example embodiments, the function module 118 is to generate a function call based on the function command and input data. The function module 118 may access the data repository 122 of FIG. 1 to associate a particular function command and input data with a corresponding function call. Alternatively or additionally, the function module may forward the function command and/or one or more input data to an application module (e.g., application modules 120 and/or 108, both of FIG. 1). In various example embodiments, the function module 118 may forward function-related data (e.g., function command, function calls and/or input data) to the communication module 114 that in turn may forward the information to the application module 108. In some example embodiments, the function module 118 may forward function-related data to the application module 120.

The application module 120 may optionally provide function output in response to an email message embedding a function command and input data. In some example embodiments, the function output may be provided by the application module 120 within the email machine 112, which also receives the email message. Alternatively or additionally, as described above, the application module 108 may generate the function output after receiving a function call or other function related data from the email machine 112 via function module 118, the communication module 114 and the transmission media 103 of FIG. 1. It may be noted that the application modules 120 and/or 108 may access the data repository 122 to associate a particular function command and input data with a corresponding function call.

The data repository 122 may further contain account information related to a sender of the email message and/or a receiver of the email message. In an example embodiment, the application module 120 is to identify a payor account associated with an email address (e.g., belonging to the sender) and a payee account associated with an email receiver (e.g., belonging to the payee). Based on a payment function embedded within the email message, the application modules 108 and/or 120 may access a data repository such as the data repository 122 to credit the payee's account with funds from the payor's account.

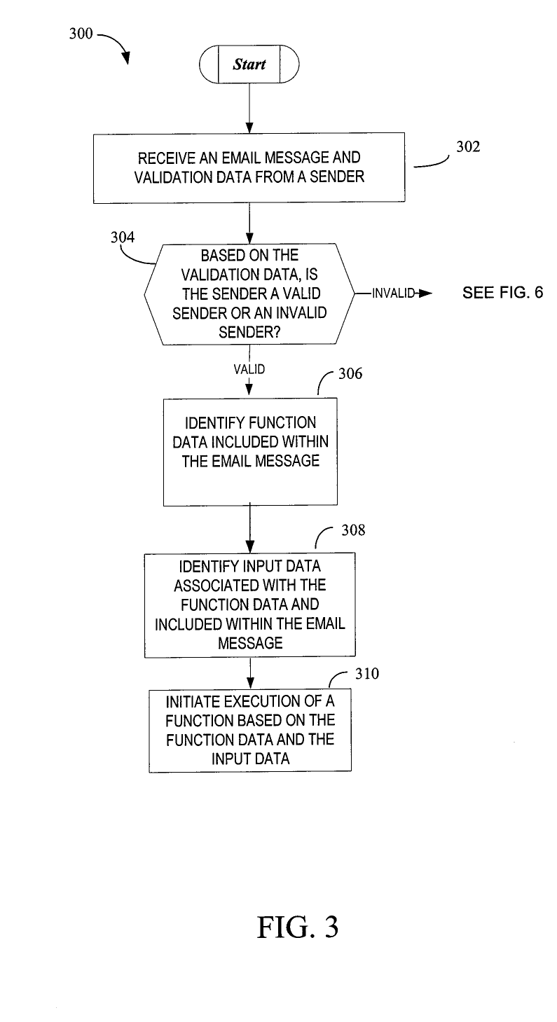

FIG. 3 is a flow diagram illustrating an example method 300 for initiating a function with an email message, in accordance with an example embodiment. For example embodiments, the activity described in the blocks of the method 300 may be performed by various modules, components and/or instructions described with respect to the email machine of FIG. 1, which may include hardware, software or a combination of hardware and software. In an example embodiment, portions of the method 300 are performed through the execution of instructions represented in an example embodiment, by the communication module 114, the validator 116 and the function module 118 of FIG. 1.

At block 302, the method 300 may include the communication module 114 receiving an email message from a sender operating the client machine 104 of FIG. 1. In some embodiments, the client machine may include a desktop machine, a mobile machine, or any other machine that executes instruction allowing the transmission of an email message to a recipient over a network such as the Internet.

At block 304, the method 300 may include the validator 116 determining whether the sender is a valid sender or an invalid sender, based on validation data associated with the email message.

Referring to FIG. 1, the communication module 114 may receive the email message via the email server 106, which is associated with the sender. The validation data included within the email message may include the sender's email address and a certificate associating a public key with a registered email address. The registered email address may be registered (e.g., with a third party certificate authority) as being associated with the public key (e.g., that is used to digitally sign the email message).

In example embodiments in which the email message is digitally signed, the validation data may further include a fingerprint of the original email message that is encrypted with the public key associated (e.g., registered via the sender's email address) with the sender.

Responsive to receiving the validation data, the validator 114 may: fingerprint the received email message; decrypt the fingerprint of the original email message with the public key; and determine whether the decrypted fingerprint of the original email message matches the fingerprint of the received email address. In an example embodiment, a match between the fingerprints of the received and original email message indicates a valid sender.

In some example embodiments, the validator 116 may obtain the registered email address and to determine validation, the validator 116 may determine whether the sender email address matches the registered email address.

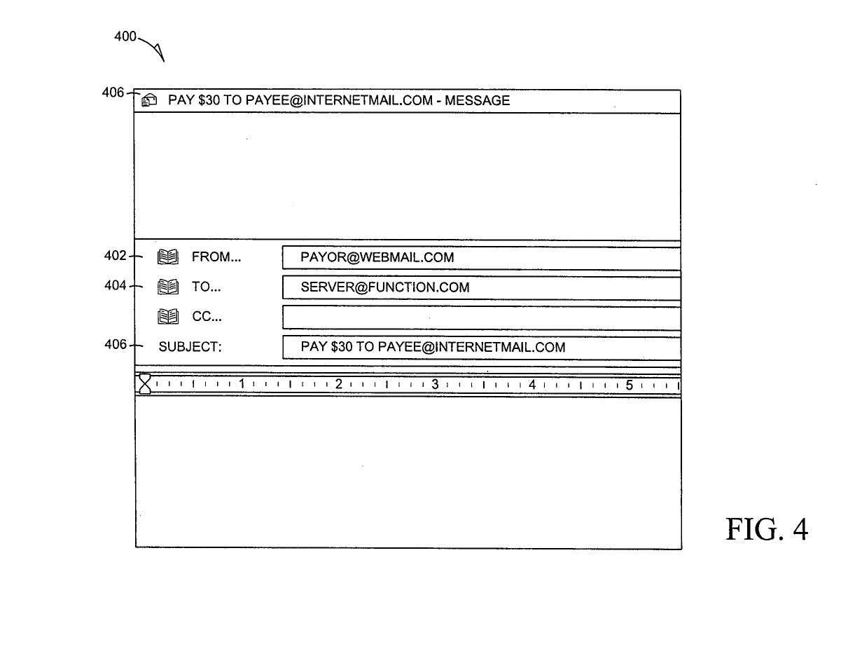

FIG. 4 illustrates an example email message interface 400 that may be used to generate an email message with a payment command, in accordance with some example embodiments. The email message interface 400 is shown to include a “From” field indicating that an email message being generated is from a user with the email address: “payor@webmail.com.”

In various example embodiments, an email address such as “payor@webmail.com” in the “From” field 402 may be associated with a value holding account. For example, an email address may be an identifier for a bank account, credit account, gift account, rewards account and the like.

The email message interface 400 is further shown to include a “To” field indicating that the email message interface 400 is to a user with the email address: “server@function.” It may be noted that a user may include a human user and/or a user that is a machine or a program based on instructions executed by a processor. For some example embodiments, a user with the email address in the “To” field 404 includes a secure server (e.g., such as the email machine 112 of FIG. 1) that may initiate execution of a function based on the email message interface 400.

The email message interface is further shown to include a “Subject” field 406 indicating a subject of an email message. The “Subject” field is shown to include the subject “Pay $30 to payee@internetmail.com.” In various example embodiments the “Subject” field may include the function commands and/or input data that have been described above. For example, function commands may include the words “Pay” and “To” while input data may include the strings “$30” and “payee@internetmail.com.”

In an example embodiment that includes a payment from one user to another, both the email address associated with the “From” field 402 and an email address associated with the “Subject” field 406 may each identify a value holding account of any type. Of course, users' email addresses are not limited to being associated with a value holding account. Any entity or subject matter may be associated with an email address without departing from the claimed subject matter.

Referring again to FIG. 3, at block 304, the method 300 may include the function module 118 of FIG. 1 behaving differently based on whether the decrypted fingerprint of the original email message matches the fingerprint of the received email address.

If the sender is determined to be a valid sender, the example method may continue with block 306. At block 306, the example method 300 may include the function module 118 identifying function data included within the received email message and at 308, input data associated with the function data. The identification of function and input data may occur in parallel (e.g., simultaneously) or in series (e.g., one after another).

Alternatively or additionally, input data may be provided or retrieved from other than the email message. In an example embodiment, the function module 118 is to request input data from a machine connected to the network 102 such as the data repository 122. The particular input data provided or retrieved may depend on the function data included in the email message.

In example embodiments, the function module 118 is to identify a function command (e.g., “Pay,” “To” or any other function command) in the subject field of the email message, and identify the input data in the subject line of the email message (e.g., “$30,” “payee@internetmail.com,” any dollar or currency amount, any recipient or any other type of function input).

At block 310, the method 300 may include the function module 118 initiating the execution of a function, based on the function data and the input data. In some example embodiments, the example function module 118 is to generate a function call associated with the example function command and the input data. The example function module 118 may then forward the function call to the example application module 108 or 120 both of FIG. 1 that may execute a function based on the function call.

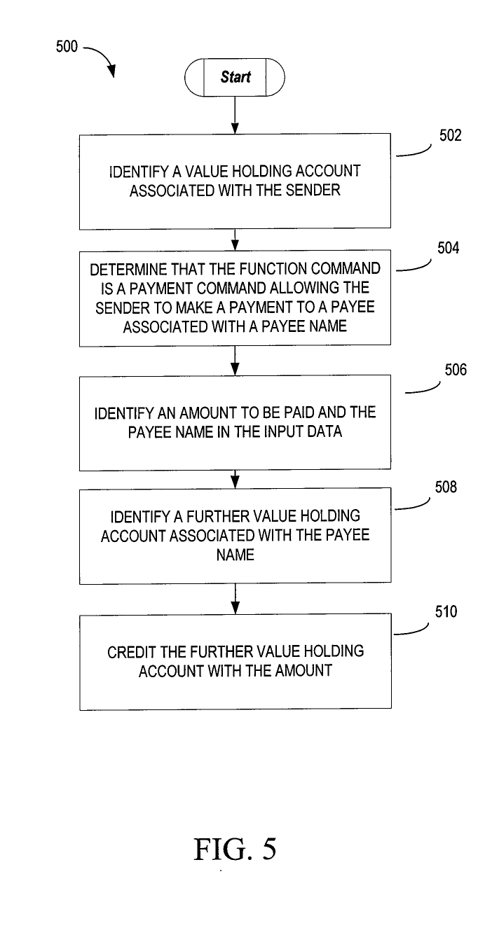

Returning to block 304 of FIG. 3, a determination is made (e.g., by the validator) whether the sender of the email message is a valid sender. FIG. 5 includes example embodiments of further activity with respect determining a valid sender and blocks 306, 308 and 310 described above.

FIG. 5 is a flow diagram illustrating a method 500 for crediting a value holding account with an amount, in accordance with an example embodiment. In example embodiments, the application module 108 of FIG. 1 and/or the application module 120 of FIG. 1 may implement the example method 500.

At block 502, the example method 500 may include the application module 120 accessing the data repository 122 of FIG. 1 to identify a value holding account associated with the validated sender of the email message.

At block 504, the example method 500 may include the example application module 120 determining that the function command is a payment command (e.g., as described above) allowing the sender to make a payment to a payee associated with a payee name. At block 506, the example method 500 may include the application module 120 identifying an amount to be paid and the payee name in the input data (e.g., as described above).

At block 508, the example method 500 may include the application module 120 accessing the data repository 122 to identify a value holding account associated with the payee name. At block 510, the example method 500 may include the application module 120 crediting the further value holding account with the amount determined from the input data.

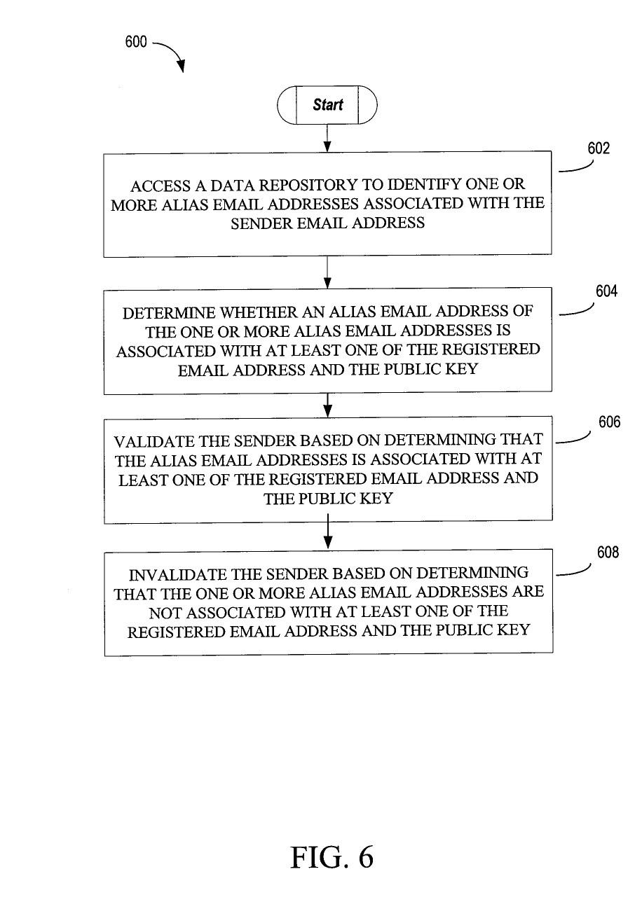

If the validator 116 of FIG. 1 determines that the decrypted fingerprint of the original email message does not match the fingerprint of the received email address, the method may continue in FIG. 6.

FIG. 6 is a flow diagram illustrating a method 600 for determining whether a sender may be validated based on an alias identity, in accordance with an example embodiment. For some example embodiments, the validator 116 of FIG. 1 is to implement the activity shown in the blocks of the example method 600.

At block 602, the example method 600 may include the validator 116 of FIG. 1 accessing the data repository 122 of FIG. 1 to identify or more alias email addresses associated with the sender email address. An association between the alias email address and the sender's email address may include both email address being registered to the same user. For example, the sender may be the registered user of a hotmail, yahoo, enterprise and any other email account.

At block 604, the example method 600 may include the validator 116 of FIG. 1 accessing the data repository 122 to determine whether one of the identified alias email addresses is associated with either or both of the of the registered email address and the public key. The data repository 122 may include tables associating email addresses with email addresses registered to be associated with public keys.

At block 606, the example method 600 may include validating the sender based on determining that the alias email addresses is associated with at least one of the registered email address and the public key. If the alias email address is associated with the sender email address and the registered email address, the alias email address may indicate a valid sender. Alternatively or additionally, if the public key associated with the registered email address is also associated with the alias email address, the sender may be determined to be valid.

At block 608, the example method 600 may include the validator 116 invalidating the sender based on making a determination that any identified alias email addresses are not associated with either the registered email address or the public key.

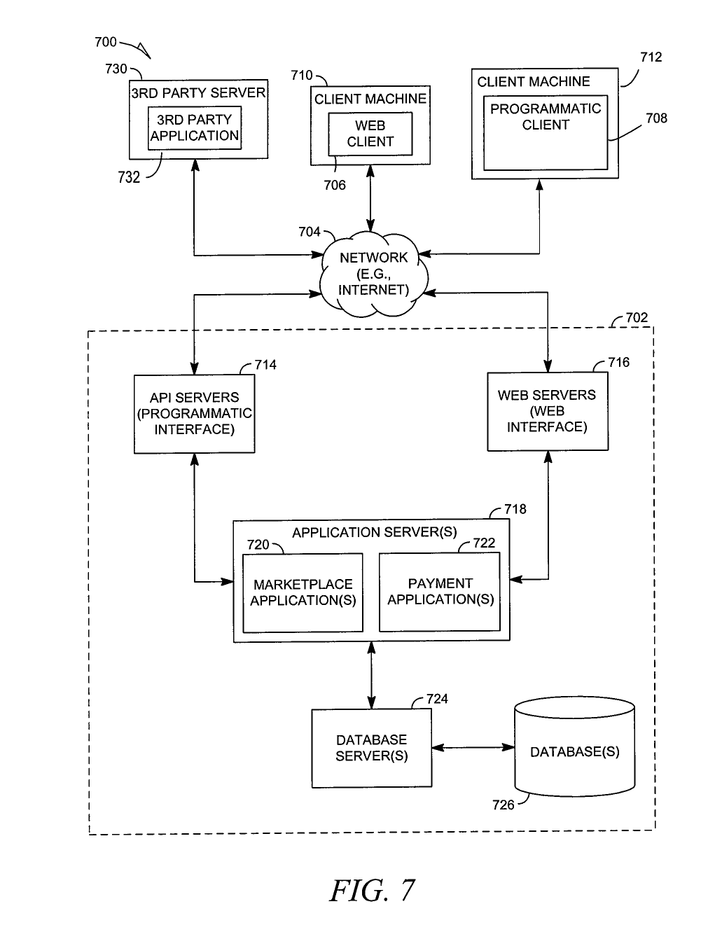

FIG. 7 is a network diagram depicting a client-server system 700, in accordance with an example embodiment.

A networked system 702, in the example forms of a network-based marketplace or publication system, provides server-side functionality, via a network 704 (e.g., the Internet over a WAN) to one or more clients. FIG. 7 illustrates, for example, a web client 706 (e.g., a browser, such as the Internet Explorer browser developed by Microsoft Corporation of Redmond, Wash. State), and a programmatic client 708 executing on respective client machines 710 and 712.

An Application Program Interface (API) server 714 and web servers 716 are communicatively coupled to, and provide programmatic and web interfaces respectively to, one or more application servers 718. The application servers 718 host one or more marketplace applications 720 and payment applications 722.The application servers 718 are, in turn, shown to be coupled to one or more databases servers 724 that facilitate access to one or more databases 726.

The marketplace applications 720 and the payment applications 722 may exist in a production environment, where the applications 720 and 722 provide functions and services associated with actual commercial activity relating to subject matter of value and real users or entities. Alternatively or additionally the marketplace applications 720 and the payment applications 722 may exist in a testing environment (e.g., testing of API calls) associated with fictitious commercial activity relating to fictitious subject matter and fictitious users or entities.

The marketplace applications 720 may provide a number of marketplace functions and services to users that access the networked system 702. The payment applications 722 may likewise provide a number of payment services and functions to users. The payment applications 722 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 720. While the marketplace and payment applications 720 and 722 are shown in FIG. 7 to both form part of the networked system 702, it will be appreciated that, in alternative embodiments, the payment applications 722 may form part of a payment service that is separate and distinct from the networked system 702.

Further, while the system 700 shown in FIG. 7 employs client-server architecture, the present subject matter is, of course, not limited to such an architecture, and could equally well find application in a distributed, or peer-to-peer, architecture system, for example. The various marketplace and payment applications 720 and 722 could also be implemented as standalone software programs, which do not necessarily have networking capabilities.

The programmatic client 708 accesses the various services and functions provided by the marketplace and payment applications 720 and 722 via the programmatic interface provided by the API server 714. The programmatic client 708 may, for example, be a seller application (e.g., the TurboLister application developed by eBay Inc., of San Jose, Calif.) to enable sellers to author and manage listings on the networked system 702 in an off-line manner, and to perform batch-mode communications between the programmatic client 708 and the networked system 702.

The web client 706 may access the various marketplace and payment applications 720 and 722 via the one or more web interface supported by the web servers 716. As described above, the example web client 706 (e.g., a web browser) may be used an interface to submit API calls and related information for the purpose of testing an API call.

FIG. 7 also illustrates a third party application 728, executing on a third party server machine 730, as having programmatic or web access to the networked system 702 via the network 704. For example, the third party server machine 730 may be an email server having a server client relationship with one or more of the client machines 710 and 712. In some example embodiments, the third party server 730 may be substantially similar to the email server 106 discussed with respect to FIG. 1. A user of the client machine 710 may compose an email message including a function command to make a payment to another user. Such an email message may be transmitted from the client machine 710 to the third party server 730 and before the third party server 730 forwards the email message to the application servers 718. Of course, email messages from the client machine 710 including function commands may include other than payment commands without departing from the claimed subject matter.

Alternatively or additionally, the third party application 728 may, utilizing information retrieved from the networked system 702, support one or more features or functions on a website hosted by the third party. The third party website may, for example, provide one or more promotional, marketplace or payment functions that are supported by the relevant applications of the networked system 702.

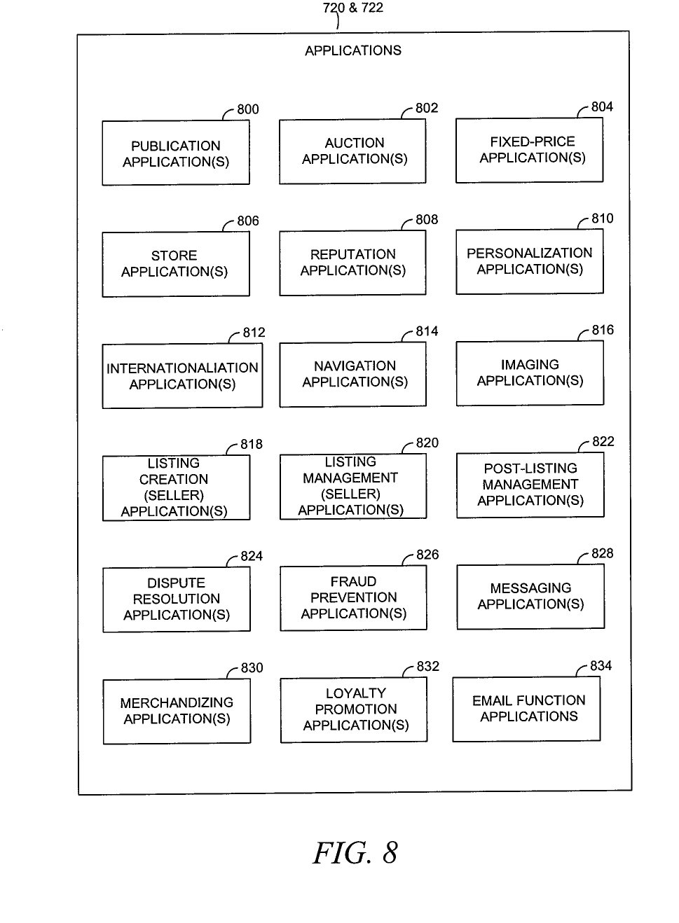

FIG. 8 is a block diagram illustrating multiple applications 720 and 722 of FIG. 7 that, in one example embodiment, are provided as part of the networked system 702 of FIG. 7. The applications 720 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access one or more databases 726 via the database servers 724 of FIG. 7.

The networked system 702 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 720 are shown to include at least one publication application 800 and one or more auction applications 802 which support auction-format listing and price setting mechanisms (e.g., English, Dutch, Vickrey, Chinese, Double, Reverse auctions etc.). The various auction applications 802 may also provide a number of features in support of such auction-format listings, such as a reserve price feature whereby a seller may specify a reserve price in connection with a listing and a proxy-bidding feature whereby a bidder may invoke automated proxy bidding.

One or more of the applications 720 and 722 may allow an email message from a client machine 710 and/or 712 (e.g., carrying a function command and input data) to make use of functionality provided by one or more of the other applications 720 and 722.

A number of fixed-price applications 804 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 806 allow a seller to group listings within a “virtual” store, which may be branded and otherwise personalized by, and for, the seller. Such a virtual store may also offer promotions, incentives and features that are specific and personalized to a relevant seller.

Reputation applications 808 allow users that transact, utilizing the networked system 702 of FIG. 7, to establish, build and maintain reputations, which may be made available and published to potential trading partners. Consider that where, for example, the networked system 702 supports person-to-person trading, users may otherwise have no history or other reference information whereby the trustworthiness and credibility of potential trading partners may be assessed. The reputation applications 808 allow a user, for example through feedback provided by other transaction partners, to establish a reputation within the networked system 702 over time. Other potential trading partners may then reference such a reputation for the purposes of assessing credibility and trustworthiness.

Personalization applications 810 allow users of the networked system 702 to personalize various aspects of their interactions with the networked system 702. For example a user may, utilizing an appropriate personalization application 810, create a personalized reference page at which information regarding transactions to which the user is (or has been) a party may be viewed. Further, a personalization application 810 may enable a user to personalize listings and other aspects of their interactions with the networked system 702 and other parties.

The networked system 702 may support a number of marketplaces that are customized, for example, for specific geographic regions. A version of the networked system 702 may be customized for the United Kingdom, whereas another version of the networked system 702 may be customized for the United States. Each of these versions may operate as an independent marketplace, or may be customized (or internationalized) presentations of a common underlying marketplace. The networked system 702 may accordingly include a number of internationalization applications 812 that customize information (and/or the presentation of information) by the networked system 702 according to predetermined criteria (e.g., geographic, demographic or marketplace criteria). For example, the internationalization applications 812 may be used to support the customization of information for a number of regional websites that are operated by the networked system 702 and that are accessible via respective web servers 716 of FIG. 7.

Navigation of the networked system 702 may be facilitated by one or more navigation applications 814. For example, a search application (as an example of a navigation application) may enable key word searches of listings published via the networked system 702. A browse application may allow users to browse various category, catalogue or inventory data structures according to which listings may be classified within the networked system 702. Various other navigation applications may be provided to supplement the search and browsing applications.

In order to make listings, available via the networked system 702, as visually informing and attractive as possible, the marketplace applications 720 may include one or more imaging applications 816 utilizing which users may upload images for inclusion within listings. An imaging application 816 also operates to incorporate images within viewed listings. The imaging applications 816 may also support one or more promotional features, such as image galleries that are presented to potential buyers. For example, sellers may pay an additional fee to have an image included within a gallery of images for promoted items.

Listing creation applications 818 allow sellers conveniently to author listings pertaining to goods or services that they wish to transact via the networked system 702 and listing management applications 820 allow sellers to manage such listings. Specifically, where a particular seller has authored and/or published a large number of listings, the management of such listings may present a challenge. The listing management applications 820 provide a number of features (e.g., auto-relisting, inventory level monitors, etc.) to assist the seller in managing such listings. One or more post-listing management applications 822 may also assist sellers with a number of activities that typically occur post-listing. For example, upon completion of an auction facilitated by one or more auction applications 802, a seller may wish to leave feedback regarding a particular buyer. To this end, a post-listing management application 822 may provide an interface to one or more reputation applications 808, so as to allow the seller conveniently to provide feedback regarding multiple buyers to the reputation applications 808.

Dispute resolution applications 824 provide mechanisms whereby disputes arising between transacting parties may be resolved. For example, the dispute resolution applications 824 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 826 implement fraud detection and prevention mechanisms to reduce the occurrence of fraud within the networked system 702.

Messaging applications 828 are responsible for the generation and delivery of messages to users of the networked system 702, such messages for example advising users regarding the status of listings at the networked system 702 (e.g., providing “outbid” notices to bidders during an auction process or to provide promotional and merchandising information to users). Respective messaging applications 828 may utilize any one have a number of message delivery networks and platforms to deliver messages to users. For example, messaging applications 828 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, Wi-Fi, WiMAX) networks.

Merchandising applications 830 support various merchandising functions that are made available to sellers to enable sellers to increase sales via the networked system 702. The merchandising applications 830 also operate the various merchandising features that may be invoked by sellers, and may monitor and track the success of merchandising strategies employed by sellers.

The networked system 702 itself, or one or more parties that transact via the networked system 702, may operate loyalty programs that are supported by one or more loyalty/promotions applications 832. For example, a buyer may earn loyalty or promotions points for each transaction established and/or concluded with a particular seller, and be offered a reward for which accumulated loyalty points can be redeemed.

The email function application 834 in example embodiments may allow a sender to use functionality provided by one or more of the applications 720-722. For some example embodiments, the email function applications 834 may receive an email message from a client machine 710 or 712, process the email message and forward a function call to the one or more applications 720, 722 on behalf of the sender of the email address.

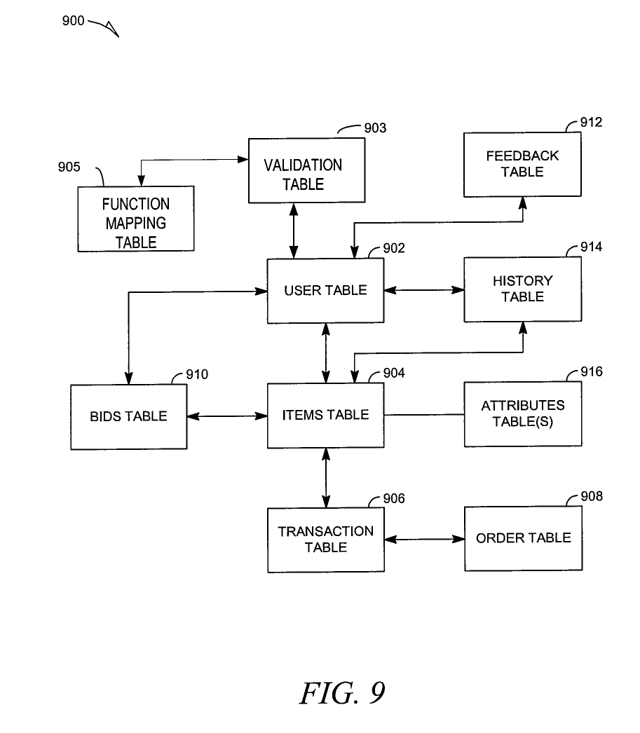

FIG. 9 is a high-level entity-relationship diagram, illustrating various tables 900 that may be maintained within the databases 726, and that are utilized by and support the applications 720 and 722 of FIG. 7. A user table 902 contains a record for each registered user of the networked system 702 of FIG. 7.

FIG. 7, and may include identifier, users' first and last names, users' email addresses, alias email addresses, financial instrument information and other information pertaining to each such user. A user may operate as a seller, a buyer, or both, within the networked system 702. In one example embodiment, a buyer may be a user that has accumulated value (e.g., commercial or proprietary currency), and is accordingly able to exchange the accumulated value for items that are offered for sale by the networked system 702.

A validation table 903 may include tables referenced for the purpose of validating a sender of an email message. The validation table 904 may be linked with the user table 902. Similar to the technique described above with respect to the validator 116 of FIG. 1, the validation table 904 may be accessed to confirm that an email address or an alias email address belongs to a user, to associate an email address with an email address registered to be associated with a public key.

A function mapping table 905 may be accessed to associate a function command in an email message to a function call used to elicit a function from a particular application. The function mapping table 905 may be linked to the validation table 903. In an example embodiment, access to the function mapping table 905 is depends upon on whether a sender is considered to be a valid sender.

The tables 900 also include an items table 904 in which are maintained item records for goods and services that are available to be, or have been, transacted via the networked system 702 of FIG. 7. Each item record within the items table 904 may furthermore be linked to one or more user records within the user table 902, so as to associate a seller and one or more actual or potential buyers with each item record.

A transaction table 906 contains a record for each transaction (e.g., a purchase or sale transaction) pertaining to items for which records exist within the items table 904.

An order table 908 is populated with order records, each order record being associated with an order. Each order, in turn, may be with respect to one or more transactions for which records exist within the transaction table 906.

Bid records within a bids table 910 each relate to a bid received at the networked system 702 of FIG. 7 in connection with an auction-format listing supported by an auction application 802 of FIG. 8. A feedback table 912 is utilized by one or more reputation applications 808 of FIG. 8, in one example embodiment, to construct and maintain reputation information concerning users. A history table 914 maintains a history of transactions to which a user has been a party. One or more attributes tables 916 record attribute information pertaining to items for which records exist within the items table 904. Considering only a single example of such an attribute, the attributes tables 916 may indicate a currency attribute associated with a particular item, the currency attribute identifying the currency of a price for the relevant item as specified in by a seller.

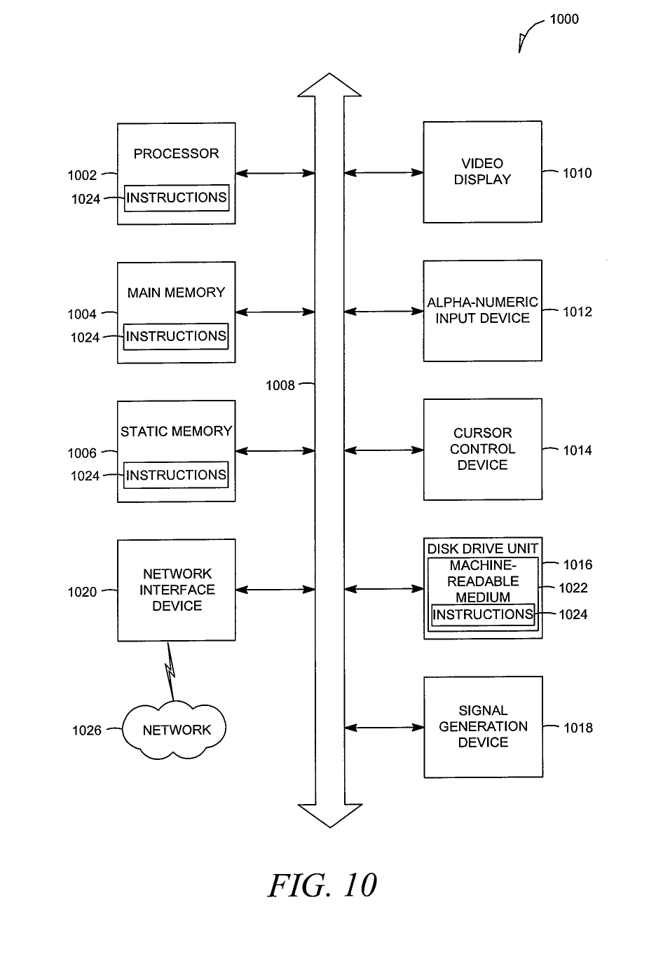

FIG. 10 shows a diagrammatic representation of a machine in the example form of a computer system 1000 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a CPU) a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a cursor control device 1014 (e.g., a mouse), a disk drive unit 1016, a signal generation device 1018 (e.g., a speaker) and a network interface device 1020.

The disk drive unit 1016 includes a machine-readable medium 1022 on which is stored one or more sets of instructions 1024 (e.g., software) embodying any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media.

The instructions 1024 may further be transmitted or received over a network 1026 via the network interface device 1020.

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present subject matter. The term “machine-readable medium” shall accordingly be taken to include, but not be limited to, solid-state memories, optical and magnetic media and carrier wave signals.

The above description is intended to be illustrative, and not restrictive. For example, the above-described embodiments (or one or more aspects thereof) may be used in combination with each other. Other embodiments will be apparent to those of skill in the art upon reviewing the above description. The scope of the claims should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on subject matter.

The Abstract is provided to comply with 37 C.F.R. §1.72(b), which requires that it allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

What is claimed is:

1. A computer implemented method comprising:
receiving an email message from a sender, the email message including a payment command;
based on an email address of the sender, validating the sender; and
based on validating the sender, allowing the payment command to be executed.

2. The method of claim 1, wherein the email message is received from the sender via a mobile machine.

3. The method of claim 1, wherein the validating of the sender includes comparing the email address of the sender with stored email addresses.

4. The method of claim 3, wherein the stored email addresses comprises at least one alias of the email address of the sender.

5. The method of claim 3, wherein the email message received from the sender is encrypted using a private key associated with the sender.

6. The method of claim 5, further comprising:
decrypting the email message received from the sender.

7. The method of claim 1, wherein the payment command is included in a subject field of the email message.

8. The method of claim 7, wherein the executing of the payment command comprises transmitting the payment command to an application associated with the payment command.

9. The method of claim 8, wherein the email message further includes one or more payment command parameters in the subject field of the email message.

10. The method of claim 9, wherein the one or more payment command parameters include information about a payee and information about an amount to be paid to the payee.

11. The method of claim 10, wherein the application associated with the command is to:
identify a value holding account associated with the sender of the email message;
identify a value holding account associated with the payee; and
transfer the amount from the account associated with the sender to the account associated with the payee.

10. A system comprising:
a processor;
a communication module communicatively coupled to the processor to receive an email message from a sender, the email address including a payment command;
a validator communicatively coupled to the communication module, the validator to validate the sender, based on an email address of the sender; and
a function module communicatively coupled to the validator, the function module to allow the payment command to be executed, based on validating the sender.

11. The system of claim 10, wherein the email message is received from the sender via a mobile machine.

12. The system of claim 10, wherein the validator is to validate the sender via comparing the email address of the sender with a stored email address.

13. The system of claim 12, wherein the stored email addresses includes at least one alias of the email address of the sender.

14. The system of claim 13, wherein the email message received from the sender is encrypted using a private key associated with the sender

15. The system of claim 12, wherein the validator is to decrypt the email message received from the sender.

16. The system of claim 10, wherein the payment command is included in a subject field of the email message.

17. The system of claim 16, further comprising:
an application module communicatively coupled to the function module, the application module being associated with the payment command, wherein the function module is to transmit the payment command to the application module and the application module is to execute the payment command.

18. The system of 17, wherein the email message further includes one or more payment command parameters in the subject field of the email message.

19. The method of claim 18, wherein the one or more payment command parameters include information about a payee and information about an amount to be paid to the payee.

20. The method of claim 19, wherein the application module is to identify a value holding account associated with the sender of the email message, identify a value holding account associated with the payee, and transfer the amount from the account associated with the sender to the account associated with the payee.

21. A machine-readable medium containing instructions that when executed by a processing system, cause the processing system to perform a method, the method comprising:
receiving an email message from a sender;
determining whether the sender is a valid sender or an invalid sender, based on validation data in the email message; and
based on determining that the sender is the valid sender:
identifying function data included within the received email message;
initiating execution of a function based on the function data.

22. The machine-readable medium of claim 21, wherein the receiving of the email message includes receiving the email message from a mobile machine.

23. The machine-readable medium of claim 21, wherein receiving the email message includes receiving the received email message via an email server associated with the sender, and the validation data includes:
a sender email address associated with the sender; and
a certificate associating a public key with a registered email address, registered as being associated with the public key, and the determining of whether the sender is the valid sender or the invalid sender includes:
obtaining the registered email address from the certificate; and
determining whether the sender email address matches the registered email address, wherein a match indicates a valid sender.

24. The machine-readable medium of claim 23, wherein the validation data further includes:
a digital signature including a fingerprint of an original email message, encrypted by a private key associated with the sender.

25. The machine-readable medium of claim 24, wherein determining whether the sender is the valid sender or the invalid sender further includes:
fingerprinting the received email message; and
decrypting the fingerprint of the original email message with the public key and determining whether the decrypted fingerprint of the original email message matches the fingerprint of the received email address, wherein a further match further indicates the valid sender.

26. The machine-readable medium of claim 23, wherein responsive to determining that the sender email address does not match the registered email address, the method includes:
accessing a data repository to identify one or more alias email addresses associated with the sender email address;
determining whether an alias email address of the one or more alias email addresses is associated with at least one of the registered email address and the public key;
validating the sender based on determining that the alias email addresses is associated with at least one of the registered email address and the public key; and
invalidating the sender based on determining that the one or more alias email addresses are not associated with at least one of the registered email address and the public key.

27. The machine-readable medium of claim 21, wherein the identifying of the function data includes identifying a function command in a subject field of the email message, and the identifying of the input data includes identifying the input data in the subject field of the email message.

28. The machine-readable medium of claim 27, wherein initiating the execution of the function includes transmitting a function call associated with the function command and the input data to an application associated with the function call.

29. The machine-readable medium of claim 21, including identifying input data in the subject field of the email message, wherein the input data is associated with the function data.

30. The machine-readable medium of claim 29, wherein based on determining that the sender is the valid sender, the method further includes:
identifying a value holding account associated with the sender;
determining that the function command is a payment command allowing the sender to make a payment to a payee associated with a payee name;
identifying an amount to be paid and the payee name in the input data;
identifying a further value holding account associated with the payee name; and
crediting the further value holding account with the amount.
